(19) United States
(12) Patent Application Publication
(10) Pub. No.: US 2025/0298902 A1
(43) Pub. Date: Sep. 25, 2025

(54) MULTIMODAL LARGE LANGUAGE MODEL (LLM)-BASED THREAT MODELING

(71) Applicant: American Express Travel Related Services Company, Inc., New York, NY (US)

(72) Inventor: Hiranmayi Palanki, Tampa, FL (US)

(21) Appl. No.: 18/613,610

(22) Filed: Mar. 22, 2024

(51) Int. Cl. G06F 21/57

(52) U.S. Cl. CPC G06F 21/577

(57) ABSTRACT

Disclosed are various approaches for multimodal large language model (LLM) based threat modeling. The multimodal LLM based threat modeling can include a system or method that can input, into a threat modeling multimodal LLM, prompting data that includes audio data, image data, and LLM instructions to generate application security data. The threat modeling multimodal LLM can generate and provide application security data that includes at least one of: threat data, weakness data, security control data, a security risk summarization, an application threat model, or any combination thereof.

### BACKGROUND

Threat modeling can provide a transparent view security and network communications of an application. Threat modeling of applications can help an enterprise to identify and document potential security threats. This can enable administrators of the enterprise to make informed decisions and undertake appropriate security mitigation actions. As a result, enterprises are performing threat modeling more often for existing and upcoming software projects that will be utilized for enterprise purposes.

In order to manually perform threat modeling, a developer must think about the overall architecture for the application, identify types of potential application threat vectors applicable to the architecture, and consider how to architect the application in view of the threats. This can be an arduous process for developers, which can take valuable time and resources away from software development itself.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment that includes components for multimodal large language model (LLM)-based threat modeling according to various embodiments of the present disclosure.

FIG. 2 illustrates an example of implementing multimodal LLM-based threat modeling using the components of the networked environment of FIG. 1 according to various embodiments of the present disclosure.

FIG. 3 illustrates an example of an image provided to the components of the networked environment of FIG. 1 for multimodal LLM-based threat modeling according to various embodiments of the present disclosure.

FIG. 4 illustrates one example of a threat model generated using the components of the networked environment of FIG. 1 according to various embodiments of the present disclosure.

FIG. 5 is a flowchart illustrating functionality of components of the networked environment of FIG. 1 according to various embodiments of the present disclosure.

FIG. 6 is a flowchart illustrating functionality of components of the networked environment of FIG. 1 and continuing the flowchart of FIG. 5 according to various embodiments of the present disclosure.

### DETAILED DESCRIPTION

Disclosed are various approaches for multimodal large language model (LLM)-based threat modeling. Secure design and threat modeling activities are increasingly prevalent. Enterprises can focus on built-in application security using the threat models. Threat modeling can be challenging with modern application designs, where an engineer or developer can deal with many interconnected components. As a result of these complex application architectures, threat modeling is not easily integrated into the development security operations toolchain. Some engineers may avoid or fail to perform threat modeling, which can hinder the secure application development process.

However, the mechanisms described herein can simplify the threat modeling process and eliminate developer toil by using audio and visual prompts to a threat model system equipped with threat modeling multimodal LLMs. The multimodal LLM-based threat modeling systems can incorporate interleaved language (audio) and visual (image) modalities to simplify threat modeling and eliminate developer toil. In some embodiments, the multimodal LLM-based threat modeling systems can use a threat model audio dataset to fine-tune the multimodal large language model on audio prompts. In some embodiments, the multimodal LLM-based threat modeling systems can use a threat model image dataset to fine-tune the multimodal large language model. The multimodal LLM-based threat modeling systems can use, in various embodiments, zero-shot prompting, one-shot prompting, few-shot prompting, and in-context multi-modal learning to train a threat modeling multimodal LLM.

The mechanisms described can provide a number of benefits over other technologies, including those that are performed using computer systems. For example, the multimodal LLM-based threat modeling concepts can improve the efficiency of using computer systems by enabling users to verbally interact with an audio prompting service that requests a user to provide one or more audio inputs describing a software application, rather than interacting with many user interface elements to design a threat model for the software manually. The multimodal LLM-based threat modeling concepts can improve the efficiency of using computer systems by enabling image-captures and image-based documentation to be uploaded or otherwise provided as a more efficient input method relative to interacting with many user interface elements to design a threat model for the software manually. The multimodal LLM-based threat modeling concepts can improve the efficiency of computer systems by reducing power usage, network bandwidth usage, and other hardware resource by reducing the developer time for threat model development relative to other methods.

In the following discussion, a general description of the multimodal LLM-based threat modeling system is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

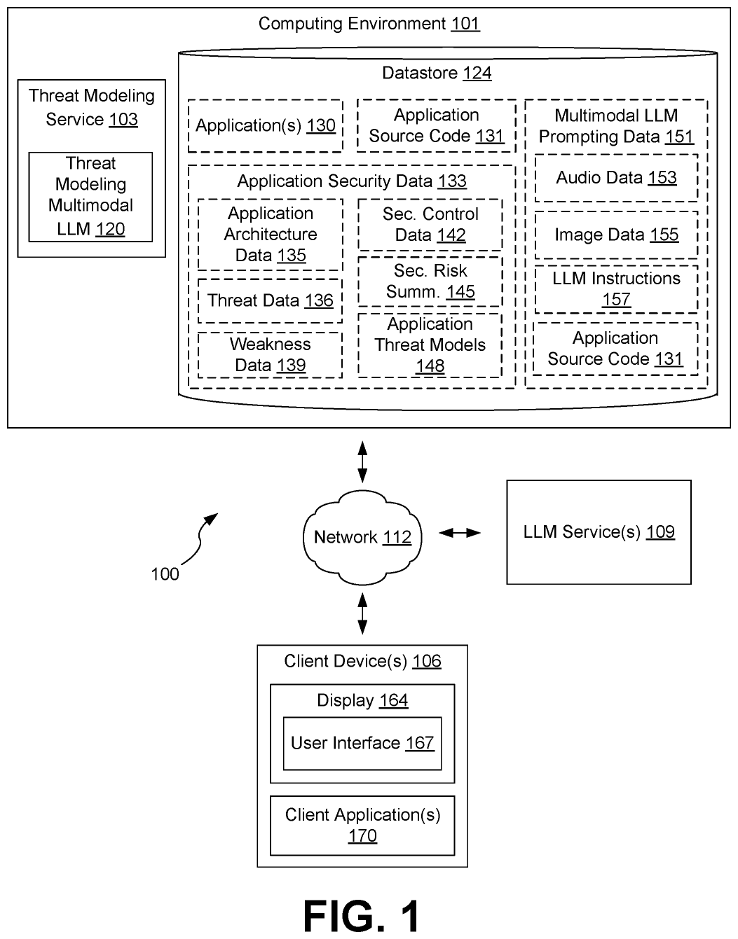

With reference to FIG. 1, shown is a networked environment 100 according to various embodiments. The networked environment 100 can include a computing environment 101 for a threat modeling service 103, a client device 106, and one or more LLM services 109, which can be in data communication with each other via a network 112. Although depicted and described separately, the LLM service 109 can also be included in or operate as a subcomponent of the computing environment 101 and/or the threat modeling service 103 in various embodiments of the present disclosure. The threat modeling multimodal LLMs 120 can operate as a subcomponent of the threat modeling service 103, or as a separate service in various embodiments of the present disclosure.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The computing environment 101 can include one or more computing devices that include a processor, a memory, and/or a network interface. For example, the computing devices can be configured to perform computations on behalf of other computing devices or applications. As another example, such computing devices can host and/or provide content to other computing devices in response to requests for content. The computing environment 101 can provide an environment for the threat modeling service 103, threat modeling multimodal LLMs 120, and other executable instructions.

A threat modeling multimodal LLM 120 can refer to an LLM that is trained and/or provided with inputs that include multiple “modes” or types of data. A threat modeling multimodal LLM 120 can be trained using a training dataset. The training dataset can include curated set of example LLM output data that includes application security data 133. The application security data 133 can include one or more of application architecture data 135, threat data 136, weakness data 139, security control data 142, security summarizations 145, application threat models 148, or any combination thereof. The training dataset can also include a curated set of example multimodal user input data that includes multimodal LLM prompting data 151. The multimodal LLM prompting data 151 can include any combination of two or more of, audio data 153, image data 155, and text data. In some examples, the threat modeling multimodal LLM 120 can be trained using, and take inputs including, modes of data limited to image data 155 and audio data 153. As a result, the threat modeling multimodal LLM 120 and the threat modeling service 103 can use multimodal data to generate outputs including the application architecture data 135, threat data 136, weakness data 139, security control data 142, security summarizations 145, and application threat models 148.

The computing environment 101 can employ a plurality of computing devices that can be arranged in one or more server banks or computer banks or other arrangements. Such computing devices can be located in a single installation or can be distributed among many different geographical locations. For example, the computing environment 101 can include a plurality of computing devices that together can include a hosted computing resource, a grid computing resource or any other distributed computing arrangement. In some cases, the computing environment 101 can correspond to an elastic computing resource where the allotted capacity of processing, network, storage, or other computing-related resources can vary over time. Various applications or other functionality can be executed in the computing environment 101. The components executed on the computing environment 101 include a threat modeling service 103, and other applications, services, processes, systems, engines, or functionality not discussed in detail herein.

Various data is stored in a datastore 124 that is accessible to the computing environment 101. The datastore 124 can be representative of a plurality of datastores 124, which can include relational databases or non-relational databases such as object-oriented databases, hierarchical databases, hash tables or similar key-value datastores, as well as other data storage applications or data structures. Moreover, combinations of these databases, data storage applications, and/or data structures can be used together to provide a single, logical, datastore. The data stored in the datastore 124 is associated with the operation of the various applications or functional entities described below.

The data is stored in a datastore 124 can include applications 130, application source code 131, application security data 133, among other items which can include executable and non-executable data. The applications 130 can, for example, be stored as application images in various repositories of a repository service of the datastore 124.

A repository can include one or more application 130. An application 130 can refer to a binary or executable of any kind of software application. The application 130 can include a compiled version of application source code 131. The application 130 can include architecture components executed using a single computing device, or the application 130 can be a distributed application executed using multiple different computing devices that communicate with one another over the network 112.

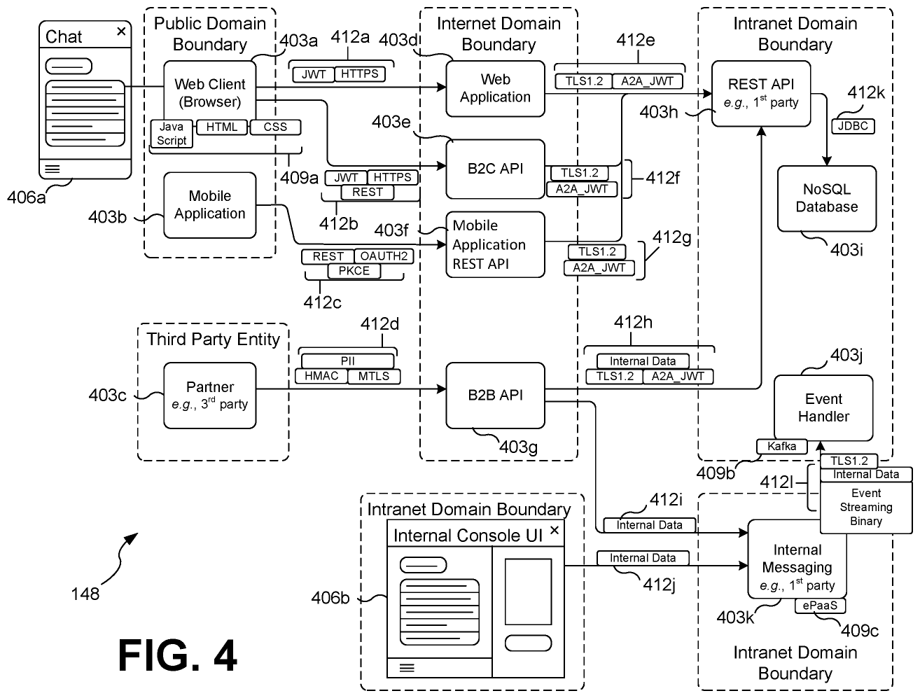

The application source code 131 can include human-readable instructions written in a programming language. The application source code 131 can provide logic that defines how an application performs a set of functionalities or actions. The application source code 131 can generally include one or more file that encodes textual information. The application source code 131 can be compiled using a compiler to generate an executable application 130. The application security data 133 can include application architecture data 135, threat data 136, weakness data 139, security control data 142, security summarizations 145, and application threat models 148. The application architecture data 135 can include application architecture components, interfaces generated in association with the application architecture components, component tags that describe the application architecture components, and connection tags that describe aspects of connections between application architecture components (See FIG. 4).

The threat data 136 can describe application security threat information that is focused on common attributes and techniques employed by threats such as adversaries that exploit known types of software weaknesses. The threat data 136 can specify that a particular component of the application 130 is vulnerable to threats such as Structured Query Language (SQL) Injection attacks, Cross-Site Scripting (XSS) attacks, session fixation, clickjacking, and other threats. Session fixation can refer to an attack that permits an attacker to hijack a user session. Clickjacking can refer to an attack that conceals malicious hyperlinks under legitimate clickable content so that the user inadvertently clicks a malicious hyperlink.

Threat data 136 can be tagged or otherwise associated with a particular application 130 component, communication link type, or network type. The threat data 136 can include a unique threat identifier and can further indicate hierarchical categorization or taxonomy data. As a result, a unique threat identifier can be categorized under a hierarchy of mechanisms of attack, a hierarchy of domains of attack, or any combination thereof. The unique threat identifier be arranged or categorized under multiple different taxonomies, multiple different top-level categories, multiple different subcategories thereof.

A mechanism of attack can refer to types of activities that exploit a predetermined vulnerability. Example mechanisms of attack can include engaging in deceptive interactions, abusing existing functionalities, manipulating data structures, injecting unexpected items, employing probabilistic techniques, manipulating timing and state, collecting and analyzing information, and subverting access control, among others. A domain of attack can refer to categorizations based at least in part on the medium or type of delivery such as software, hardware, network communications, supply chain, social engineering, physical security, and so on. The threat data 136 can include Common Attack Pattern Enumeration and Classification (CAPEC™) data or other information that indicates threats according to a publicly available catalog of threat patterns, where each threat pattern is associated with a predetermined schema and at least one classification taxonomy.

The weakness data 139 can include information for weaknesses that result from application architectural design and coding practices that can result in software security vulnerabilities. The weakness data 139 can be tagged or otherwise associated with a particular application 130 component, communication link type, or network type. The weakness data 139 can include a unique weakness identifier and can further indicate can include a unique weakness identifier and can further indicate hierarchical categorization or taxonomy data. The unique weakness identifier be arranged or categorized under multiple different taxonomies, multiple different top-level categories, multiple different subcategories thereof.

The top-level categories for weakness data 139 can include software development weaknesses, hardware design weaknesses, research concept weaknesses, and others. Subcategories of software development weaknesses can include errors and issues with Application Programming Interfaces (APIs), audits, authentication, authorization, coding, behavior, business logic, communication channels, credentials, key management, complexity, concurrency, cryptography, data integrity, data processing, data neutralization, documentation, file handling, encapsulation, status conditions/values/codes, expressions, handlers, information management, initialization, cleanup, data validation, lockout, memory buffer, permissions, pointers, privileges, random numbers, resource locking, resource management, signals, strings, type, user interface security, user sessions, and others. Subcategories of hardware design weaknesses can include issues identified with manufacturing and life cycle management; security flow; integration; privilege separation and access control; circuit and logic design; core and compute issues; memory and storage; peripherals, on-chip fabric, and interface input output; security primitives and cryptography; power, clock, thermal, and reset; debug and test; cross-cutting; and physical access. The weakness data 139 can include Common Weakness Enumeration (CWE) data or other information that indicates weaknesses according to a publicly available catalog of weakness types, where each weakness is associated with a predetermined schema and at least one classification taxonomy.

The security control data 142 can specify security controls that can mitigate, prevent, or otherwise counter threats and weaknesses. In some examples, the security control data 142 can indicate a predetermined enterprise-specific action that is to be performed in response to an application 130 weakness or threat. In other examples, the security control data can indicate a security control specified by a developer rather than one identified by the system based at least in part on predetermined associations.

A security risk summarization 145 can include a textual summary paragraph or set of sentences in plain language that describes threats, weaknesses, and security controls of an application 130. The threat modeling service 103 can use the threat modeling multimodal LLM 120 to generate the security summarizations 145 based at least in part on the application architecture data 135, threat data 136, weakness data 139, the security control data 142, or any combination thereof. The threat modeling service 103 can additionally or alternatively use the threat modeling multimodal LLM 120 to generate the security summarizations 145 based at least in part on an application threat model 148.

An application threat model 148 can refer to a data flow diagram that visually shows the application architecture data 135, threat data 136, weakness data 139, and security control data 142 in a diagrammatic form. An application threat model 148 can include application architecture data 135 such as application architecture components, data connections between application architecture components, and user interfaces generated in association with the application architecture components. The application threat model 148 can also provide tags that can indicate information about the components and the data connections of the application 130. The application architecture data 135 of an application threat model 148 can indicate or be associated with at least a subset of the threat data 136, weakness data 139, and security control data 142 for an application 130. The component tags and connection tags can also indicate at least a subset of the threat data 136, weakness data 139, and security control data 142 for an application 130.

The application threat model 148 can refer a data flow diagram in an image form or a dynamic user interface that enables user interactions with the data flow diagram using a threat modeling software suite. User selection of a component, a connection, a user interface, or a tag in the application threat model 148 can cause a user interface element to provide a textual description of the threat data 136, weakness data 139, and security control data 142 for the selected component, connection, user interface, or tag.

The application threat models 148 shown can include diagrams that are manually generated and those generated using the threat modeling multimodal LLM 120 and the threat modeling service 103. The manually generated application threat models 148 can be used to train the threat modeling multimodal LLM 120. The application threat models 148 can include a networking architecture of software and/or hardware components of the application 130.

The application threat models 148 can include at least a set of architecture components of the application 130 that communicate with other components of the application 130. A component can include a bottom-level category of the component such as a name, title, or type of the component. A component can also include a unique component identifier. A component can be tagged or associated with data that indicates characteristics of the component. In some examples, the tag data can indicate at least one higher-level type or category of the component. A component can include one or more network connection lines that connect from that component to another component of the application 130. The network connection lines can be tagged or associated with data that indicates at least one category of the network connection line, which can include types of content transmitted, a protocol used to transmit the data, a format of the data, and other information. The application threat models 148 can be generated based at least in part on one or more of the application architecture data 135, threat data 136, weakness data 139, the security control data 142, the security summarizations 145, or any combination thereof.

The threat modeling service 103 can include and/or coordinate programs and instructions that generate and store application security data 133 in association with an application 130. As the application 130 is processed from an initial version to a branch variant, the threat modeling service 103 can attach the application security data 133. This can include the generation of application architecture data 135, threat data 136, weakness data 139, security control data 142, security summarizations 145, and application threat models 148 based at least in part on audio data 153 and image data 155 provided by a developer. The threat modeling service 103 can utilize a single threat modeling multimodal LLM 120 or multiple different threat modeling multimodal LLM 120 in parallel or arranged in multiple stages. The one or more threat modeling multimodal LLMs 120 can generate application architecture data 135, threat data 136, weakness data 139, security control data 142, security summarizations 145, and application threat models 148.

The threat modeling service 103 generate a user interface that elicits audio data 153 from a user. The threat modeling service 103 can generate multimodal LLM prompting data 151 for the user-provided audio data 153. The multimodal LLM prompting data 151 can include LLM instructions 157 such as text, audio, and images that can instruct the threat modeling multimodal LLM 120 to generate the application security data 133 using the audio data 153. The multimodal LLM prompting data 151 can use LLM instructions 157 to indicate which type or subset of the application security data 133 to generate as well as how to format, phrase, and otherwise generate the application security data 133.

In a zero-shot prompting embodiment, the multimodal LLM prompting data 151 can include LLM instructions 157 and omit examples of application security data 133. In a one-shot prompting embodiment, the multimodal LLM prompting data 151 can further include LLM instructions 157 and one example of each requested type of the application security data 133. In a few-shot prompting embodiment, the multimodal LLM prompting data 151 can include LLM instructions 157 and multiple examples of each requested type of the application security data 133. The multimodal LLM prompting data 151 can also include the recorded audio data 153. The threat modeling service 103 can provide the multimodal LLM prompting data 151 and the audio data 153 as inputs to a threat modeling multimodal LLM 120.

The threat modeling service 103 can generate a user interface that elicits image data 155 from a user. The threat modeling service 103 can generate multimodal LLM prompting data 151 for the user-provided audio data 153. The multimodal LLM prompting data 151 can include LLM instructions 157 such as text, audio, and images that can instruct the threat modeling multimodal LLM 120 to generate the application security data 133 using the image data 155. The multimodal LLM prompting data 151 can use text, audio, and images to indicate which type or subset of the application security data 133 to generate as well as how to format, phrase, and otherwise generate the application security data 133. The threat modeling service 103 can generate multimodal LLM prompting data 151 using zero-shot prompting, one-shot prompting, and few-shot prompting as described for the audio aspects of the service. The multimodal LLM prompting data 151 can also include the image data 155. The threat modeling service 103 can provide the multimodal LLM prompting data 151 and the audio data 153 as inputs to a threat modeling multimodal LLM 120.

The threat modeling service 103 can generate multimodal LLM prompting data 151 for the source code 131 of an application 130, and provide this information as input to the threat modeling multimodal LLM 120 along with the audio data 153 and the image data 155. While the threat modeling multimodal LLM 120 can use audio data 153 and the image data 155 to identify application architecture data 135 for an application 130, the application source code 131 of an application 130 can also be instrumental in identification of the application architecture data 135. This can include the architectural components and the connections (e.g., communications) between architectural components of an application 130. The application source code 131 can also help the threat modeling multimodal LLM 120 to identify a complete view of the application 130 including information that the user may overlook or fail to provide as audio data 153 and image data 155.

The threat modeling multimodal LLM 120 can take the audio data 153, the image data 155, the application source code 131 and the corresponding LLM instructions 157 as multimodal LLM prompting data 151. The threat modeling multimodal LLM 120 can generate the application architecture data 135, the threat data 136, the weakness data 139, the security control data 142, the security summarizations 145, and the application threat models 148. In some examples, the user provided data can omit text data. In some examples, the prompting data can omit text data. However, in further examples, the multimodal LLM prompting data 151 can include text data, while the user provided data can omit text data.

The threat modeling service 103 can automatically notify a developer and launch the audio data elicitation user interface 203 and/or the image data elicitation user interface 206 to provide audio data 153 and image data 155 to generate an application threat model 148. For example, the threat modeling service 103 can identify that the application 130 is in a particular repository associated with a particular pipeline position or stage of development. Pipeline positions can in some examples be associated with particular repositories or development environments, and can further indicate or associate responsible users, particular enterprise groups or business units, and so on. The repositories can include main and branch repositories that can enable management and tracking of versions and changes.

Branches can provide a sub-repository for the developer to safely make changes to a particular subset of code without affecting the rest of a project and other versions or variants of the project. All of the changes in various branches of a main repository can be tracked and reverted by a repository service. Generating a particular branch repository or type of branch repository can be associated with a starting point for generation of an application threat model 148. The threat modeling service 103 can detect generation of a branch repository and initiate multimodal LLM-based generation of an application threat model 148 for the application 130. Once generated, the application threat model 148 can be stored in association with the application 130 in the repository.

The client device 106 is representative of a plurality of client devices 106 that can be coupled to the network 112. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 164, such as liquid crystal displays (LCDs), gas plasma-based flat panel displays, organic light emitting diode (OLED) displays, electrophoretic ink (“E-ink”) displays, projectors, or other types of display devices. In some instances, the displays 164 can be a component of the client device 106 or can be connected to the client device 106 through a wired or wireless connection.

The client device 106 can be configured to execute various applications such as a client application 170 or other applications. The client application 170 can be executed in a client device 106 to access network content served up by the computing environment 101 or other servers, thereby rendering a user interface 167 on the displays 164. To this end, the client application 170 can include a browser, a dedicated application, or other executable, and the user interface 167 can include a network page, an application screen, or other user mechanism for obtaining user input. The client device 106 can be configured to execute client applications 160 such as browser applications, chat applications, messaging applications, email applications, social networking applications, word processors, spreadsheets, or other applications.

The threat modeling multimodal LLM 120 can utilize a network-accessible LLM service 109, or can be fully hosted using the computing environment 101. The LLM service 109 can include a service that provides an LLM such as a multimodal LLM as a service. The LLM service 109 can expose one or more APIs that enable applications 130 to send text inputs and receive generated outputs from an LLM. The threat modeling service 103 can utilize the LLM service 109, training a multimodal LLM to take the audio data 153, the image data 155, and associated multimodal LLM prompting data 151 to generate the application threat models 148 and other application security data 133.

The threat modeling multimodal LLM 120 can refer to a multimodal LLM such as GPT-4 (Generative Pre-trained Transformer 4) from OpenAIR, Kosmos-1from Microsoft®, or other multimodal generative artificial intelligence models. The threat modeling multimodal LLM 120 can be trained using a training set of audio data 153 and image data 155 that is correlated with a training set of application architecture data 135, threat data 136, weakness data 139, security control data 142, security summarizations 145, and application threat models 148. The training process can include the identification of image data 155 and audio data 153 that indicates the threat modeling service 103 should provide a particular set of multimodal LLM prompting data 151 in association with the image data 155 and/or the audio data 153.

Outputs from the threat modeling multimodal LLM 120 can include multiple modes of data including image data 155, audio data 153, textual data, executable code, and data files that can be opened using threat modeling software. In one nonlimiting example, the application architecture data 135, threat data 136, weakness data 139, security control data 142, and security summarizations 145, can include textual data and data files that can be opened using appropriate software. The application architecture data 135 can be generated as a text-based document, an image, or any combination thereof. The application threat models 148 can include image data 155, audio data 153, textual data, executable code, and data files that can be opened using threat modeling software.

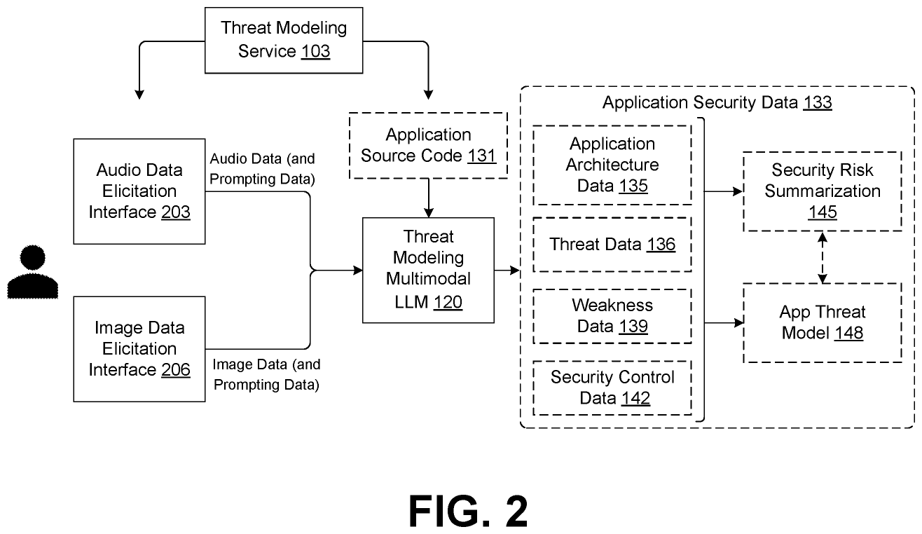

FIG. 2 shows an example of how the threat modeling service 103 can orchestrate the components of the networked environment 100 for multimodal LLM-based threat modeling. The threat modeling service 103 can utilize or provide the audio data elicitation interface 203 and the image data elicitation interface 206 to elicit user-provided information that describes an application 130.

The threat modeling service 103 can generate an audio data elicitation interface 203. The audio data elicitation interface 203 can provide text, image, video, and multimedia instructions that guide a user to audibly describe specified aspects of the application 130. The user can speak into a microphone or other audio-capture device of a client device 106 in order to audibly describe the specified aspects of the application 130. The specified aspects of the application 130 can include any one or more of threat information, weakness information, security control information, architecture components used, protocols used for communications between specified architecture components, or any combination thereof. The audio data elicitation interface 203 can guide the user to describe each architecture component of the application 130, as well as describe threat information, weakness information, security control information and connections to other architecture components. The audio data elicitation interface 203 can also guide the user to describe information for the overall application 130.

The threat modeling service 103 can also generate LLM instructions 157 for the audio data 153. The LLM instructions 157 can include natural language text that indicates a context of the audio data 153. The LLM instructions 157 and can also provide instructions for how the threat modeling multimodal LLM 120 is to use the audio data 153 to generate application security data 133. The following can be a nonlimiting example of LLM instructions 157 that instruct the threat modeling multimodal LLM 120 to generate security control data 142 for audio data 153 describing a particular application 130 and/or an architecture component thereof:
I will give you an audio description of a web application's security controls. Process it. Extract the type of the sound and summarize each output into one sentence. Each security control description should be less than 20 words. Ensure there are no grammatical errors. Output “Invalid Security control” if the sound input is not related to security controls.
   The threat modeling service 103 can also prompt the threat modeling multimodal LLM 120 to process additional audio data 153 that describes application architecture data 135, threat data 136, weakness data 139, and so on. The multimodal LLM prompting data 151 can be designed to cause the threat modeling multimodal LLM 120 to generate one or more of application architecture data 135, threat data 136, weakness data 139, security control data 142, a security risk summarization 145, an application threat model 148, or any combination thereof, based at least in part on the audio data 153. The multimodal LLM prompting data 151 can include the LLM instructions 157 and the associated audio data 153.

The threat modeling service 103 can generate an image data elicitation interface 206. The image data elicitation interface 206 can provide text, image, video, and multimedia user interface elements that prompt a user to provide images that describe specified aspects of the application 130. The user can upload image data 155 such as an image file that shows a listing of one or more specified architecture components of the application 130. The user can provide one or more image that lists one or more of: threat information, weakness information, security control information, components used, protocols used for communications between specified components, or any combination thereof.

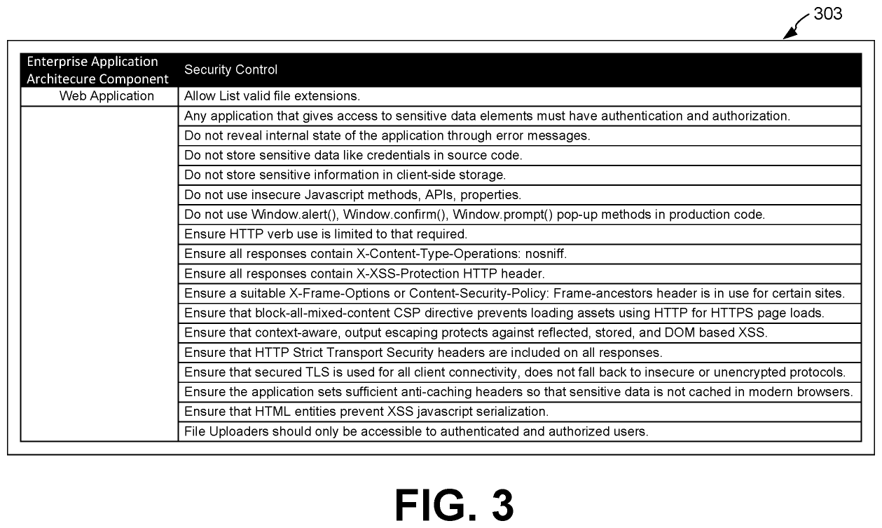

The image data elicitation interface 206 can receive images including that shown in FIG. 3, among other images for other architecture components and types of information. Image data elicitation interface 206 can receive an image that shows an architecture block diagram of architecture components and connections. The image data 155 can also include images that shows a list or table that associates a particular architecture component with a set of communicatively connected architecture components of the application 130.

The image data elicitation interface 206 of the threat modeling service 103 can additionally or alternatively provide instructions for a user navigate through a user interface of the client device 106 that visually depicts a listing of one or more specified architecture components of the application 130, and describes one or more of: threat information, weakness information, security control information, architecture components used, protocols used for communications between specified architecture components, or any combination thereof. The threat modeling service 103 can automatically take screen captures as static image data 155 and/or dynamic (video) image data 155 as the user navigates through the requested information. The image data elicitation interface 206 can also instruct the user to interact with a user interface element to perform a static image capture action. The image data elicitation interface 206 can also instruct the user to interact with a user interface element to start and end capturing dynamic image data 155. The image data elicitation interface 206 can guide the user to provide images that provide threat information, weakness information, and security control information for a respective component and the overall application 130. The image data elicitation interface 206 can guide the user to provide images that show a list or other graphical representation of each architecture component of the application 130.

The threat modeling service 103 can generate LLM instructions 157 for the image data 155. The LLM instructions 157 can include natural language text that indicates a context of the image data 155. The LLM instructions 157 and can also provide instructions for how the threat modeling multimodal LLM 120 is to use the image data 155 to generate application security data 133. The following can be a nonlimiting example of LLM instructions 157 that instruct the threat modeling multimodal LLM 120 to generate security control data 142:
I will give you an image description of a web application's security controls. Process it. Summarize each output into one sentence. Each security control description should be less than 20 words. Ensure there are no grammatical errors. Output “Invalid Security control,” if the image input is not related to security controls.
   The threat modeling service 103 can also prompt the threat modeling multimodal LLM 120 to process additional image data 155 that describes application architecture data 135, threat data 136, weakness data 139, and so on. The multimodal LLM prompting data 151 can be designed to cause the threat modeling multimodal LLM 120 to generate one or more of application architecture data 135, threat data 136, weakness data 139, security control data 142, a security risk summarization 145, an application threat model 148, or any combination thereof, based at least in part on the image data. The multimodal LLM prompting data 151 can include the LLM instructions 157 and the associated audio data 153.

In some examples, the multimodal LLM prompting data 151 can include a set of natural language LLM instructions 157 provided in association with the audio data 153, and another set of textual LLM instructions 157 in association with the image data. However, the threat modeling service 103 can also provide LLM instructions 157 that are integrated together such that a single set of LLM instructions 157 describes how the threat modeling multimodal LLM 120 is to process the audio data 153 and image data 155 into the application security data 133. The threat modeling service 103 can provide the audio data 153, image data 155, and LLM instructions 157 as multimodal LLM prompting data 151 that causes the threat modeling multimodal LLM 120 generate and output the application security data 133.

In some examples, the threat modeling multimodal LLM 120 can generate a first subset of the application security data 133, and the threat modeling service 103 can provide an additional LLM prompt that instructs the threat modeling multimodal LLM 120 to use the first subset of the application security data 133 to generate a second subset of the application security data 133. In one nonlimiting example, the threat modeling multimodal LLM 120 can generate the application architecture data 135, threat data 136, the weakness data 139, and the security control data 142 as textual outputs from the threat modeling multimodal LLM 120. In some examples, the threat modeling multimodal LLM 120 can generate the application architecture data 135 as textual data, image data, or another format. The threat modeling multimodal LLM 120 can process the image data 155 and audio data 153 directly, rather than performing optical character recognition and voice recognition to convert this data to textual data for processing. The threat modeling multimodal LLM 120 can process the LLM instructions 157 as text in some examples, and in other examples, the LLM instructions 157 can be provided as audio, image, or video data.

The threat modeling service 103 can generate and provide the threat modeling multimodal LLM 120 with an LLM prompt that instructs the threat modeling multimodal LLM 120 to use the application source code 131, the threat data 136, the weakness data 139, and the security control data 142 to generate a textual security risk summarization 145 of a predetermined length such as a number of sentences, words, lines, paragraphs, or and combination thereof. The threat modeling multimodal LLM 120 can generate the security risk summarization 145.

The threat modeling service 103 can also generate and provide the threat modeling multimodal LLM 120 with an LLM prompt that instructs the threat modeling multimodal LLM 120 to use the threat data 136, the weakness data 139, the security control data 142, the security risk summarization 145, or any combination thereof to generate the application threat model 148. The threat modeling multimodal LLM 120 can generate the application threat model 148 as an image and/or as a file that can be opened using a threat modeling software suite. A user can open the file to interact with the application threat model 148. The application threat model 148 can include a visual and interactive representation of enterprise application architecture components in association with one or more of threat data 136, weakness data 139, security control data 142, security risk summarization 145, or any combination thereof.

FIG. 3 shows an example of an image 303 that the image data elicitation interface 206 receives or generates based at least in part on user interactions. The image 303 can include image data 155 that the image data elicitation interface 206 has elicited from a user. The image 303 can include a listing of architecture components of an application 130. In this example the architecture components can include a web app. While a single architecture component is shown, multiple architecture components of the application 130 can be included in the image 303.

Additional images can describe other components. One or more images can also be provided such that multiple architecture components of the application 130 are described using the image data 155 elicited by the image data elicitation interface 206. In some examples, each of the architecture components of the application 130 are described in one or more images in the image data 155.

The image 303 includes a list or table of architectural components and security controls to apply to the application 130. Alternatively, the architectural components and corresponding security controls can be shown in an image formatted as a flowchart, diagram, or another visual aid. In some examples, the image 303 can represent a screen capture of a portion of a developer user interface that describes the “web application” architectural component in development for the application 130. The image 303 shows one architectural component of an application 130, which is shown as “web application.” The image 303 shows a number of security controls that are indicated for the web application architectural component. The image 303 can correspond to a set of notes indicating goals and/or currently applied security controls. Certain security controls can be achieved using a particular set of architecture components in association with “web application” type architectural components. The threat modeling multimodal LLM 120 can use the image data 165 of the image 303 to generate security control data 142 and application architecture data 135 without applying optical character recognition to the image 303.

The threat modeling multimodal LLM 120 can use the information in the image data 165 of the image 303 to identify security control data 142 and architectural data 135 for the web application architectural component of the application 130. The image 303 shows the web application and the security controls in a graphical table format. The security controls include “Allow List valid file extensions;” “Any application that gives access to sensitive data elements must have authentication and authorization;” “Do not reveal internal state of the application through error messages;” “Do not store sensitive data like credentials in source code;” “Do not store sensitive information in client-side storage;” “Do not use insecure Javascript methods, APIs, properties;” “Do not use Window.alert( ), Window.confirm( ), Window.prompt( ) pop-up methods in production code;” “Ensure Hypertext Transfer Protocol (HTTP) verb use is limited to that required;” “Ensure all responses contain X-Content-Type-Operations: nosniff.” “Ensure all responses contain X-XSS-Protection HTTP header;” “Ensure a suitable X-Frame-Options or Content-Security-Policy (CSP): Frame-ancestors header is in use for certain sites;” “Ensure that block-all-mixed-content CSP directive prevents loading assets using HTTP for HTTPS page loads;” “Ensure that context-aware, output escaping protects against reflected, stored, and Document Object Model (DOM) based Cross-Site Scripting (XSS);” “Ensure that HTTP Strict Transport Security headers are included on all responses;” “Ensure that secured Transport Layer Security (TLS) is used for all client connectivity, does not fall back to insecure or unencrypted protocols;” “Ensure the application sets sufficient anti-caching headers so that sensitive data is not cached in modern browsers;” “Ensure that HyperText Markup Language (HTML) entities prevent XSS javascript serialization;” “File Uploaders should only be accessible to authenticated and authorized users.” “X-Content-Type-Operations: nosniff” can refer to is an HTTP security header that prevents browsers from interpreting files as a different Multipurpose Internet Mail Extension type than declared by the source or server. “X-XSS” can mean “cross-site scripting,” and an “X-XSS-Protection HTTP header” can provide protection against cross-site scripting. “X-frame options” can refer to an HTTP header option that controls inline frames, for example, to prevent clickjacking and other attacks.

Other images (not shown) can include a table or other visual indication of threats for an architectural component of an application 130, a list or graphical indication of weaknesses for an architectural component of an application 130, and a list or graphical indication of architectural components of an application 130. The threat modeling multimodal LLM 120 can use the image data 165 that shows one or more architectural component to generate application architecture data 135 for the application 130. The threat modeling multimodal LLM 120 can use the image data 165 that shows one or more threats to generate threat data 136 in association with the application 130 and one or more architecture components. The threat modeling multimodal LLM 120 can use the image data 165 that shows one or more weaknesses to generate weakness data 139 in association with the application 130 and one or more architecture components. The threat modeling multimodal LLM 120 can use the image data 165 that shows one or more security controls to generate security control data 142 in association with the application 130 and one or more architecture components. The threat modeling multimodal LLM 120 can use the image 303 and other images to generate application architecture data 135, threat data 136, weakness data 139, security control data 142, security risk summaries 145, and application threat models 148 without applying optical character recognition to the image 303.

FIG. 4 shows an example of an application threat model 148 generated for an application 130 using the components of the networked environment 100. The application threat model 148 can include enterprise application architecture components 403a-403k (“the enterprise application architecture components 403”), interfaces 406a-406b (“the interfaces 406”), component tags 409a-409c (“the component tags 409”), and interaction or connection tags 412a-4121 (“the connection tags 412”).

The threat modeling multimodal LLM 120 can use the image 303 to generate at least a portion of the enterprise application architecture components 403, the interfaces 406, and the component tags 409. The threat modeling multimodal LLM 120 can use the image 303 to generate the “web application” enterprise application architecture component 403d, as well as at least a subset of the other enterprise application architecture components 403, the interfaces 406, and the component tags 409 that are associated with the security controls indicated in the image 303. The threat modeling multimodal LLM 120 can also use audio data 153 and other image data 155 (other than the image 303) to generate the application threat model 148. The threat modeling multimodal LLM 120 can also use application source code 131 to generate the application threat model 148.

The application threat model 148 can refer to a data flow diagram that includes and outlines threat data 136, weakness data 139, and security control data 142 for an application 130. The application threat model 148 can show components, data connections between components, and tags that can indicate information about the components and the data connections. In some examples, the application threat model 148 can refer to static images of the data flow diagram. However, the application threat model 148 can also refer to dynamic user interface elements that can be interacted with through a threat modeling software. The application threat model 148 can include a visual and interactive representation of the threat data 136, the weakness data 139, the security control data 142, the security risk summarization 145, or any combination thereof.

An enterprise application architecture component 403 can refer to a software module or subsection of an application 130 that can be unique and/or reusable for different applications 130. An enterprise application architecture component 403 can include a name or label that indicates a type or class of software module, even if the module is not a reusable component. An enterprise application architecture component 403 can be connected to other components using connection lines that indicate network communications such as transmissions or other interactions.

The application threat model 148 can include a “web client” enterprise application architecture component 403a, a “mobile application” enterprise application architecture component 403b, a “partner” enterprise application architecture component 403c, a “web application” enterprise application architecture component 403d, a “Business-to-Customer (B2C) API” enterprise application architecture component 403e, a “Mobile Application Representational State Transfer (REST) API” enterprise application architecture component 403f, a “Business-to-Business (B2B) API” enterprise application architecture component 403g, a “REST API” enterprise application architecture component 403h, a “Not Only Structured Query Language (noSQL)” enterprise application architecture component 403i, an “Event Handler” enterprise application architecture component 403j, and an “Internal Messaging” enterprise application architecture component 403k.

User selection of the enterprise application architecture component 403 can update a user interface to show information regarding the enterprise application architecture component 403, such as its code, a listing of component tags 409, interfaces 406, a textual description of the enterprise application architecture component 403, and so on. An enterprise application architecture component 403 can be located within a network element indicating a network, subnetwork, domain boundary, or any combination thereof. The network element can include a title of a network type of the network or subnetwork. Nonlimiting examples of network types can include “public domain boundary,” “private domain boundary,” “cloud domain boundary,” “Internet domain boundary,” “intranet domain boundary,” “demilitarized zone,” and so on.

The interfaces 406 can refer to example graphical user interfaces, audio user interfaces, programmatic data interfaces, and other interfaces of an enterprise application architecture component 403. User selection of the interface 406 can provide images, audio, and text that provide an example of the interface 406 and describe the interface 406. The application threat model 148 can include the “chat” interface 406a in association with the “Web Client” enterprise application architecture component 403a, and the “Internal Console UI” interface 406a in association with the “Internal Messaging” enterprise application architecture component 403k. In some examples, interfaces 406 can refer to separate software modules from the associated enterprise application architecture component 403.

The component tags 409 can include metadata that describes an enterprise application architecture component 403. A set of component tag 409 for a particular enterprise application architecture component 403 can indicate underlying technologies used by the tagged particular enterprise application architecture component 403. The component metadata can indicate technologies including programming languages, markup languages, scripting languages, software platforms, service types, and so on. The component tags 409 can, in some examples, directly show friendly names or identifiers for items of threat data 136 indicating specific threats, weakness data 139 indicating specific weaknesses, and security control data 142 indicating specific security controls. User selection of a particular component tag 409 can provide a textual description such as a sentence or short paragraph describing the tagged programming languages, markup languages, scripting languages, software platforms, service types, threat data 136, weakness data 139, security control data 142, and other metadata indicated by the particular component tag 409.

The “web client” enterprise application architecture component 403a can include a set of component tags 409a that indicate “JavaScript,” “HTML (HyperText Markup Language),” “CSS (Cascading Style Sheets).” A user selection of “JavaScript” can update the user interface to provide a textual description such as a sentence or short paragraph describing that JavaScript is a programming language often used for Internet applications. The updated user interface can also indicate threat data 136, weakness data 139, and security control data 142 associated with using the selected one of the component tags 409a in the specified network boundary where the enterprise application architecture component 403a is located. Selection of another one of the component tags 409a can provide a textual description such as a sentence or short paragraph describing HTML or CSS, and the threat data 136, weakness data 139, and security control data 142 associated with using the selected component tag 409 in the specified network boundary where the enterprise application architecture component 403a is located. The “web client” enterprise application architecture component 403a can also provide or be associated with the “chat” user interface 406a. A user selection of “chat” user interface 406a can provide a textual description such as a sentence or short paragraph describing the “chat” user interface 406a, along with a description of the associated threat data 136, weakness data 139, and security control data 142.

Other component tags 409 shown in FIG. 4 include “Kafka” component tag 409b and the “ePaaS” component tag 409c. A user selection of the “Kafka” component tag 409b can provide a textual description indicating that “Kafka” is an open-source distributed event streaming platform, and that the “event handler” 403j uses this platform. This information can be provided along with a description of the associated threat data 136, weakness data 139, and security control data 142. A user selection of the “ePaaS” component tag 409c can provide a textual description indicating that “ePaaS” means Endpoint Protection as a Service (ePaaS), and that the “internal messaging” architecture component 403k corresponds to an ePaaS; this information can be provided along with a description of the associated threat data 136, weakness data 139, and security control data 142 of ePaaS in the context of the “internal messaging” architecture component 403.

The “web client” enterprise application architecture component 403a can connect to the web application 403d. A connection line between these enterprise application architecture components 403 can include connection tags 412a JavaScript Object Notation (JSON) Web Token (JWT) and Hypertext Transfer Protocol Secure (HTTPS). A user selection of the “JWT” connection tag 412 can provide a textual description such as a sentence or short paragraph describing information about JWT, such as “JWT is a token standard that allows two parties to securely share security information,” along with a description of the associated threat data 136, weakness data 139, and security control data 142. A user selection of the “HTTPS” connection tag 412 can provide a textual description such as a sentence or short paragraph describing information about HTTPS, along with a description of the associated threat data 136, weakness data 139, and security control data 142 in the context of the connection line.

Additional connection tags 412 shown can include at least one “REST” connection tag 412, at least one “OAUTH” connection tag 412, at least one “PKCE” connection tag 412, at least one “PII” connection tag 412, at least one “HMAC” connection tag 412, at least one “MTLS” connection tag 412, at least one “TLS1.2” connection tag 412, at least one “A2A_JWT” connection tag 412, at least one “Internal Data” connection tag 412, and at least one “Event Streaming Binary” connection tag 412.

The “REST” connection tag 412 can indicate that the connection includes Representational State Transfer data. The “OAUTH” connection tag 412 can indicate that open authorization (OAUTH) technical standard is used for the connection. The “PKCE” connection tag 412 can indicate that Proof Key for Code Exchange (PKCE) OAUTH extension is used for the connection to improve security, for example, for public clients. The “PII” connection tag 412 can indicate that Personally Identifiable Information (PII) is one type or security level of information or data transmitted using the connection. The “HMAC” connection tag 412 can indicate that Hash-based message authentication code (HMAC) is used for data integrity and authentication using cryptographic hash function and a secret key.

The “MTLS” connection tag 412 can indicate that Mutual Transport Layer Security (mTLS) is used for mutual authentication of parties and/or components using the connection. The “TLS1.2” connection tag 412 can indicate that Transport Layer Security (TLS) version 1.2 is used for the connection. The “A2A_JWT” connection tag 412 can indicate that Application-to-Application (A2A) information is transmitted using JWT formatting. The “Internal Data” connection tag 412 can indicate that internal data is one type or security level of information or data transmitted using the connection. The “Event Streaming Binary” connection tag 412 can indicate that event streaming is performed using an event streaming binary format.

The connection tags 412 can include metadata that describes a connection between enterprise application architecture components 403. The connection tags 412 can indicate data protocols, data formats, and data classification standards, and so on. The connection tags 412 can additionally or alternatively describe information categories or types of data such as internal data, public data, personally identifying information, and so on. The connection tags 412 can, in some examples, directly show friendly names or identifiers for items of threat data 136 indicating specific threats, weakness data 139 indicating specific weaknesses, and security control data 142 indicating specific security controls. User selection of a particular connection tag 412 can provide a textual description such as a sentence or short paragraph describing the tagged data protocols, data formats, data standards, information categories, threat data 136, weakness data 139, security control data 142, and other metadata indicated by the particular connection tag 412. The updated user interface can also indicate threat data 136, weakness data 139, and security control data 142 associated with using the selected connection tag 412 in a connection between the specified network type(s) where the endpoints of the connection are located.

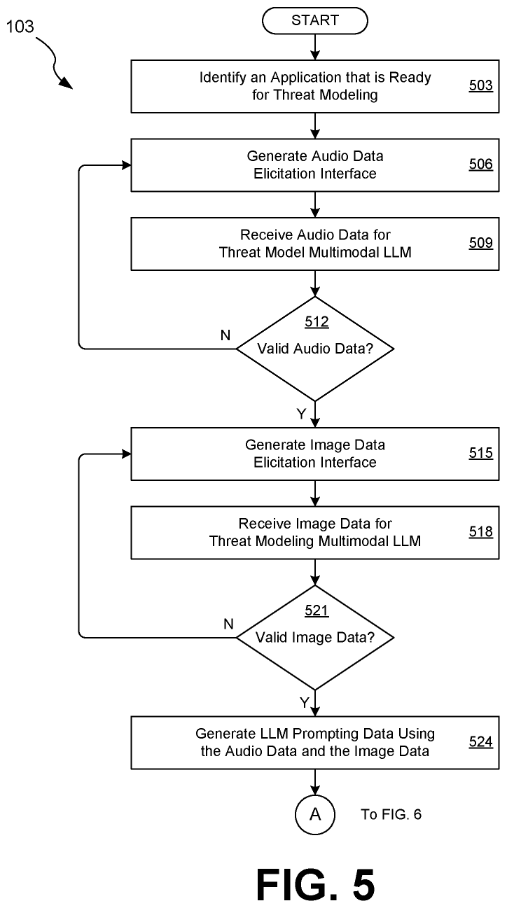

FIG. 5 is a flowchart providing an example of multimodal LLM based threat modeling using the threat modeling service 103. As an alternative, the flowchart of FIG. 5 can be viewed as depicting an example of elements of a method implemented by the threat modeling service 103 within the networked environment 100. While blocks are generally described as performed using the threat modeling service 103, this can include instructions executed by various components of the networked environment 100.

In block 503, the threat modeling service 103 can identify an application 130 that is ready for threat modeling. In some examples, the threat modeling service 103 can detect that a new main repository for a new application 130 has been created. This can trigger threat modeling prior to software development or in an early stage of development. Alternatively, the threat modeling service 103 can detect that a branch repository has been created, which can trigger threat modeling at a predetermined stage of development. For example, a branch repository can have a logical association with a particular stage of development such that the threat modeling service 103 can detect that the application 130 has entered the stage of development based at least in part on data associated with the branch repository. The threat modeling service 103 can also retrieve application source code 131 for the application 130.

In block 506, the threat modeling service 103 can generate an audio data elicitation interface 203. The threat modeling service 103 can transmit a notification to a client device 106 or console user interface accessed using the client device 106. The notification can request a developer or another user to use the audio data elicitation interface 203 to provide audio data 173 for threat modeling. The user can access the audio data elicitation interface 203 and follow the on-screen or audible instructions to provide the audio data 173.

The audio data elicitation interface 203 can provide a series of user interfaces that elicit audio data 173 from the user. For example, the user interface can display and or audibly state, “Please speak about this application's security controls. Select the user interface element to begin recording and select again to end recording.” More than one statement can be used to elicit the user to record a number of separate recordings, or a single recording can be made for all the requested information. In some examples, the threat modeling service 103 can provide additional guidance as the user is recording, such as asking whether the application 130 has particular types of security controls. The particular types of security controls can refer to categories and subcategories of security control data 142.

The audio data elicitation interface 203 can also provide a series of user interface elements that elicit information regarding threats that correspond to categories and subcategories of threat data 136. The audio data elicitation interface 203 can also provide a series of interface elements that elicit information regarding weaknesses that correspond to categories and subcategories of weakness data 139. The audio data elicitation interface 203 can show respective lists of a predetermined sets of threats, weaknesses, and security controls and can elicit or prompt the user to speak about any of the shown threats, weaknesses, and security controls that are applicable to the application 130.

In block 509, the threat modeling service 103 can receive user-provided audio data 173. For example, threat modeling service 103 can use the audio data elicitation interface 203 to record the audio data 173. The threat modeling service 103 can generate LLM instructions 177 in association with the audio data 173.

In block 512, the threat modeling service 103 can assess validity of the audio data 173 based at least in part on an audio analysis that identifies whether the audio format and/or audio content matches an expected audio format and expected audio content. If the audio data 173 is valid, then the threat modeling service 103 can proceed to image prompt creation in block 515. Otherwise, if the audio data 173 is identified as invalid, then the threat the threat modeling service 103 can notify the user that the audio data 173 is invalid and can repeat audio prompt creation in block 506.

In block 515, the threat modeling service 103 can generate an image data elicitation interface 206. The threat modeling service 103 can transmit a notification to a client device 106 or console user interface accessed using the client device 106. The notification can request a developer or another user to use the image data elicitation interface 206 to provide image data 175 for threat modeling. The user can access the image data elicitation interface 206 and follow the on-screen or audible instructions to provide the image data 175. The image data 175 can include one or more images such as the image 303 of FIG. 3.

In block 518, the threat modeling service 103 can receive user-provided image data 175. The image data elicitation interface 206 can capture or otherwise receive the image data 175 and provide it to the threat modeling service 103. The threat modeling service 103 can generate LLM instructions 177 in association with the image data 175.

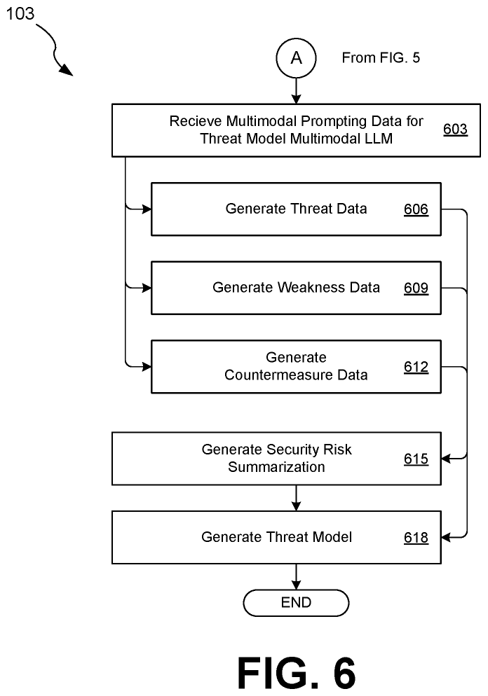

In block 521, the threat modeling service 103 can assess validity of the image data 175 based at least in part on an image analysis that identifies whether the image format or image content matches an expected image format and expected image content. If the image data 175 is valid, then the threat modeling service 103 can proceed to connector A, which continues to FIG. 6. Otherwise, if the image data 175 is identified as invalid, then the threat the threat modeling service 103 can notify the user that the image data 175 is invalid and can repeat image prompt creation in block 515.

In block 524, the threat modeling service 103 can generate multimodal LLM prompting data 171 using the application source code 131, the audio data 173 and the image data 175. The multimodal LLM prompting data 171 can include the application source code 131, the audio data 173, the image data 175, and LLM instructions 177 such as textual natural language instructions for the threat modeling multimodal LLM 120 to generate application security data 133 using the application source code 131, the audio data 173, and the image data 175. While the LLM instructions 177 can be textual, the LLM instructions 177 can also be multimodal, including text, images, and audio that provide the LLM with the appropriate instructions to generate the application security data 133.

FIG. 6 is a flowchart providing an example of multimodal LLM based threat modeling using the threat modeling service 103 and continuing from FIG. 5. As an alternative, the flowchart of FIG. 6 can be viewed as depicting an example of elements of a method implemented within the networked environment 100. While blocks are generally described as performed using the threat modeling service 103, this can include instructions executed by various components of the networked environment 100.

Block 603 can continue from connector A, which connects from FIG. 5. In block 603, the threat modeling service 103 can identify multimodal prompting data for the threat modeling multimodal LLM 120. The multimodal prompting data can include the image data 155, the audio data 153, and LLM instructions 157 that instruct the threat modeling multimodal LLM 120 to generate all or a subset of the application security data 133 using the application source code 131, the image data 155, and the audio data 153.

In block 606, the threat modeling service 103 can generate threat data 136. The threat modeling service 103 can invoke the threat modeling multimodal LLM 120 with multimodal prompting data that includes instructions for the threat modeling multimodal LLM 120 to use the application source code 131, the image data 155, and the audio data 153 to generate threat data 136. The threat data 136 can describe application security threat information that is focused on common attributes and techniques employed by threats such as adversaries that exploit known types of software weaknesses.

In block 609, the threat modeling service 103 can generate weakness data 139. The threat modeling service 103 can invoke the threat modeling multimodal LLM 120 with multimodal prompting data that includes instructions for the threat modeling multimodal LLM 120 to use the application source code 131, the image data 155, and the audio data 153 to generate weakness data 139. The weakness data 139 can include information for weaknesses that result from application architectural design and coding practices that can result in software security vulnerabilities.

In block 612, the threat modeling service 103 can generate security control data 142. The threat modeling service 103 can invoke the threat modeling multimodal LLM 120 with multimodal prompting data that includes instructions for the threat modeling multimodal LLM 120 to use the application source code 131, the image data 155, and the audio data 153 to generate security control data 142. The security control data 142 can specify security controls that can mitigate, prevent, or otherwise counter threats and weaknesses.

In block 615, the threat modeling service 103 can generate a security risk summarization 145. The threat modeling service 103 can use the threat modeling multimodal LLM 120 to generate the security risk summarization 145 based at least in part on the application architecture data 135, the threat data 136, the weakness data 139, the security control data 142, or any combination thereof. The security risk summarization 145 can include a textual summary paragraph or set of sentences in plain language that describes threats, weaknesses, and security controls of an application 130.

In block 618, the threat modeling service 103 can generate an application threat model 148. The threat modeling service 103 can use the threat modeling multimodal LLM 120 to generate application threat model 148 based at least in part on the application architecture data 135, the threat data 136, the weakness data 139, the security control data 142, or any combination thereof. An application threat model 148 can refer to a data flow diagram that visually shows the threat data 136, weakness data 139, and security control data 142 in a diagrammatic form. One example of an application threat model 148 is provided in FIG. 4. The application threat models 148 can show components, data connections between components, and tags that can indicate information about the components and the data connections of the application 130. The application threat model 148 can refer a data flow diagram in an image form or a dynamic user interface that enables user interactions with the data flow diagram using a threat modeling software suite.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages could be added to the logical flow described herein, for purposes of enhanced utility, accounting, performance measurement, or providing troubleshooting aids, etc. It is understood that all such variations are within the scope of the present disclosure.

The sequence diagrams and flowcharts provide a general description of the operation of the various components. Although the general descriptions can provide provides an example of the interactions between the various components, other interactions between the various components are also possible according to various embodiments of the present disclosure. Interactions described with respect to a particular figure or sequence diagram can also be performed in relation to the other figures and sequence diagrams herein.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
at least one computing device comprising at least one processor and at least one memory; and
machine-readable instructions stored in the at least one memory that, when executed by the at least one processor, cause the at least one computing device to at least:
generate at least one user interface comprising instructions to provide audio data that describes, for a particular application, at least one of: threats, weaknesses, security controls, or any combination thereof;
generate the at least one user interface comprising instructions to provide image data that describes, for the particular application, at least one of: the threats, the weaknesses, the security controls, or any combination thereof;
input, into a threat modeling multimodal Large Language Model (LLM), multimodal LLM prompting data comprising: the audio data, the image data, and LLM instructions for the threat modeling multimodal LLM to generate application security data using the audio data and the image data; and
receive, from the threat modeling multimodal LLM, the application security data comprising at least one of: threat data, weakness data, security control data, a security risk summarization, an application threat model, or any combination thereof.

2. The system of claim 1, wherein the LLM instructions comprise natural language instructions for the threat modeling multimodal LLM.

3. The system of claim 1, wherein the LLM instructions comprise a first LLM instruction subset for the audio data and a second LLM instruction subset for the image data.

4. The system of claim 1, wherein the application threat model comprises a data flow diagram that visually shows the threat data, the weakness data, and the security control data in a diagrammatic form.

5. The system of claim 4, wherein the data flow diagram comprises an interactive data flow diagram viewed using a threat modeling software.

6. The system of claim 4, wherein the data flow diagram comprises an image.

7. The system of claim 1, wherein the machine-readable instructions, when executed by the at least one processor, further cause the at least one computing device to at least:
receive, from the threat modeling multimodal LLM, the application security data comprising: the threat data, the weakness data, and the security control data;
input, into an LLM, the threat data, the weakness data, the security control data, and instructions for the LLM to generate the security risk summarization corresponding to a predetermined length of text that describes the threat data, the weakness data, and the security control data for the particular application.

8. A method, comprising:
training a threat modeling multimodal Large Language Model (LLM) to use audio and images to generate application security data comprising at least one of: threat data, weakness data, security control data, a security risk summarization, an application threat model, or any combination thereof, wherein the threat modeling multimodal LLM is trained using an audio input training set, an image input training set, and an application security data training set;
inputting, into the threat modeling multimodal Large Language Model (LLM), multimodal LLM prompting data comprising: audio data, image data, and LLM instructions for the threat modeling multimodal LLM to generate application security data using the audio data and the image data; and
receiving, from the threat modeling multimodal LLM, the application security data comprising the at least one of: the threat data, the weakness data, the security control data, the security risk summarization, the application threat model, or any combination thereof.

9. The method of claim 8, wherein the LLM instructions comprise natural language instructions for the threat modeling multimodal LLM.

10. The method of claim 8, wherein the LLM instructions comprise a first LLM instruction subset for the audio data and a second LLM instruction subset for the image data.

11. The method of claim 8, wherein the application threat model comprises a data flow diagram that visually shows the threat data, the weakness data, and the security control data in a diagrammatic form.

12. The method of claim 8, wherein the application threat model comprises an interactive data flow diagram viewed using a threat modeling software.

13. The method of claim 8, wherein the application threat model comprises an image.

14. The method of claim 8, further comprising:
receiving, from the threat modeling multimodal LLM, the application security data comprising: the threat data, the weakness data, and the security control data;
inputting, into an LLM, the threat data, the weakness data, the security control data, and instructions for the LLM to generate the security risk summarization as a predetermined-length of text that describes the threat data, the weakness data, and the security control data for the application.

15. A system, comprising:
at least one computing device comprising at least one processor and at least one memory; and
machine-readable instructions stored in the at least one memory that, when executed by the at least one processor, cause the at least one computing device to at least:
train a threat modeling multimodal Large Language Model (LLM) to use audio and images to generate application security data comprising at least one of: threat data, weakness data, security control data, a security risk summarization, an application threat model, or any combination thereof, wherein the threat modeling multimodal LLM is trained using an audio input training set, an image input training set, and an application security data training set;
input, into the threat modeling multimodal Large Language Model (LLM), multimodal LLM prompting data comprising: audio data, image data, and LLM instructions for the threat modeling multimodal LLM to generate application security data using the audio data and the image data; and
receive, from the threat modeling multimodal LLM, the application security data comprising the at least one of: the threat data, the weakness data, the security control data, the security risk summarization, the application threat model, or any combination thereof.

16. The system of claim 15, wherein the LLM instructions comprise natural language instructions for the threat modeling multimodal LLM.

17. The system of claim 15, wherein the LLM instructions comprise a first LLM instruction subset for the audio data and a second LLM instruction subset for the image data.

18. The system of claim 15, wherein the application threat model comprises a data flow diagram that visually shows the threat data, the weakness data, and the security control data in a diagrammatic form.

19. The system of claim 15, wherein the application threat model comprises an interactive data flow diagram viewed using a threat modeling software.

20. The system of claim 15, wherein the application threat model comprises an image of a data flow diagram.
